(19) United States
(12) Patent Application Publication
(10) Pub. No.: US 2020/0146791 A1
(43) Pub. Date: May 14, 2020

(54) Dental Prosthesis Manufacturing Method

(71) Applicant: Ivoclar Vivadent AG, Schaan (LI)

(72) Inventors: Andreas Schülke, Grabs (CH); Roger Frei, Heerbrugg (CH); Clemens Andreas Häfele, Weiler (AT); Konrad Hagenbuch, Haag (CH)

(21) Appl. No.: 16/658,231

(22) Filed: Oct. 21, 2019

(30) Foreign Application Priority Data
Nov. 12, 2018 (EP) 18205735.6

(51) Int. Cl. A61C 13/00; A61C 13/08; A61C 13/01; A61C 13/20; A61C 5/77

(52) U.S. Cl. CPC A61C 13/0019; A61C 13/0004; A61C 13/081; B33Y 80/00; A61C 13/206; A61C 5/77; A61C 13/04

(57) ABSTRACT

Positive models of a prosthesis base or partial prosthesis base are produced additively or generatively in 3D printing using a dental prosthesis manufacturing process. The model is then encapsulated with a curing negative mold production material, in particular plaster. In the next step, following curing of the casting material, the positive model is removed by heat. The negative mold of the base is filled with prosthetic material and is cured. The positive model is subsequently applied to the base and embedded together with it. The positive model of the dental crown is then removed. The resulting free space is filled with tooth material by injection.

### CROSS-REFERENCE TO RELATED APPLICATIONS

This application claims priority to European Patent Application No. 18205735.6 filed on Nov. 12, 2018, the disclosure of which is incorporated herein by reference in its entirety.

### TECHNICAL FIELD

The invention relates to a dental prosthesis manufacturing method as well as a dental prosthesis.

### BACKGROUND

Dental prostheses of this type and manufacturing methods thereof have been known for long.

Typically, the manufacturing method involves initially scanning the patient's mouth and creating a virtual model for the dental prosthesis using CAD/CAM software.

Alternatively, the impression may also be taken in the conventional manner followed by scanning.

The dental prosthesis may be either a full prosthesis or a partial prosthesis.

In a first step, the virtual model is transformed into reality such that suitable artificial teeth are selected and a prosthesis base in a milled shape is produced.

In the next step of this procedure, the teeth are installed on trial, and any occlusal defects will be eliminated.

It can also be installed virtually, thus ensuring that no post-processing will be required, or not more than polishing.

In another method, which has already been widely used for expenditure reason, the prosthesis is modeled in wax. The wax model is cast, for example using plaster or a similar material.

The cured plaster mold, i.e. the muffle, is thermally treated to remove the wax positive model. Herein, the term “remove” refers to any type of removal, such as scalding, dissolving, burning out, etc.

The result is a lost mold that will subsequently be filled with prosthetic raw material, such as PMMA-MMA mixtures.

An advantageous embodiment to provide a mold is the ivobase method, which is operated using a cuvette. In this method, the reaction mass is injected under pressure and is maintained pressurized in the polymerization process, which is started and controlled by extensive temperature control. This compensates for the polymerization shrinkage that occurs at the front end; and the resulting workpiece deviates from the existing negative shape significantly less than in conventional production.

The methods known so far either require considerable amount of manual work, which can only be in part supported by computer aid, such as model production.

On the other hand, they require considerable investments for the procurement of a CAM device including the associated milling machine, the investments being well in the five-digit euro range.

Conventionally, ablative procedures for the manufacture of dental prostheses either use prefabricated teeth or blanks made of tooth material (discs). The former suffering from the problem of having a fixed shape and size, requiring appropriate storage and showing restrictions on individualization. When using tooth material discs, an additional disc must be purchased and processed, in addition to the often expensive prosthesis base material disc.

In order to reduce costs at least to a certain extent, it has already been suggested that both the teeth which together form a dental arch or, in the case of partial prostheses, at least a partial dental arch, and the prosthesis base should be made from a common blank comprising both flesh-colored and tooth-colored material.

For this purpose, the blank disc is suitably milled, as it has become known from EP 3 064 170 A1 and corresponding US2018071063, which is hereby incorporated by reference. US 20190282345, US 20180132985, US 20180132984, US 20150132718, US 20070015109, US 20030069326 are directed to methods for preparing dentures and dental prostheses, and are hereby incorporated by reference in their entirety.

### SUMMARY

In contrast, the object of the invention is to provide a dental prosthesis manufacturing method according to the claims, and a dental prosthesis manufactured therewith according to the claims, which are easy to implement and inexpensive to carry out.

According to the invention, this object will be solved by the claims. Advantageous further embodiments will arise from the subclaims.

According to the invention, it is intended for the above mentioned positive model for the production of a dental prosthesis to be created by 3D printing. 3D printing of the dental arch, which may also be referred to as the dental crown, and the prosthesis base is preferably done separately.

According to the invention, use of inexpensive materials is possible, as is rapid creation of positive models without manual post-processing.

According to the invention, it is advantageous for the two materials to be injected into a cuvette using the ivobase method. The preferred method is to first create the shape for the dental crown and to inject the tooth material thereinto.

Following curing, the basic positive model will subsequently be placed on the dental crown and will be embedded together with it.

The basic positive model will be removed and the resulting free space is then filled up with base material by injection.

In a modified, but still preferred embodiment, the order is reversed. Then, the base is first created by injection, and in the following, the positive model of the dental crown is placed onto the base and embedded together with it.

The positive model of the dental crown is removed and the space thus created is filled up with dental material by injection.

In a particularly favorable embodiment it is intended for the positive model, as soon as it has been generated by 3D printing, to be already used for the patient's fit-in.

This step saves considerable work and time, and the positive model, for the first time, also has a dual function.

Any suitable configuration with sufficient precision can be considered to be used as a 3D printer. Cost-effective solutions are preferred, such as FDM.

It is also particularly favorable for the existing ivobase injectors to easily be used in many dental laboratories.

The dentist only needs any inexpensive 3D printer for 1000 to 2000 €, for example.

It is also advantageous that the patient's oral situation may be taken into account from both static and gnathological points of view. This represents a significant advance over the use of prefabricated teeth, which are always compromised in terms of shape.

This is particularly true for partial dental prostheses that require adaptation to the patient's existing teeth.

According to the invention, it is beneficial to make use of the advantages of digital technologies despite employing the Ivobase-InjectorSystem. CAD design of both the prosthesis base and the teeth is possible, while using autocorrection if required.

It is also possible to provide additional integrated shrinkage compensation by manufacturing the positive models with an appropriate oversize to achieve even better precision.

It is even better to maintain the injection pressure during the injection until the shrinkage is compensated.

According to the invention, it is also favorable for the prosthesis base and the dental arches to be able to be made of PMMA, so that there is low affinity for plaque, the oral resistance is strong and the teeth do not tend to discolor. Furthermore, bonding between the two injected materials then is excellent.

According to the invention, a partially automated injection molding process showing good aesthetic results is intended. Compared to ablative processes, considerably less material is required and the investment costs are significantly lower. Provisioning of prosthesis teeth in various sizes and shapes is no longer necessary due to the use of (fewer) tooth-colored system capsules.

### BRIEF DESCRIPTION OF THE DRAWINGS

Further advantages, details and features will arise from the following description of several examples of the invention, while making reference to the drawing, wherein:

FIG. 1 a is a schematic representation of an ivobase injector for performing the process according to the invention.

FIG. 1b is a schematic representation of an ivobase injector for performing the process according to the invention.

FIG. 2a is a flowchart explaining the inventive step, in one embodiment.

FIG. 2b is a flowchart explaining the inventive step, in one embodiment.

FIG. 2c is a flowchart explaining the inventive step, in one embodiment.

### DETAILED DESCRIPTION

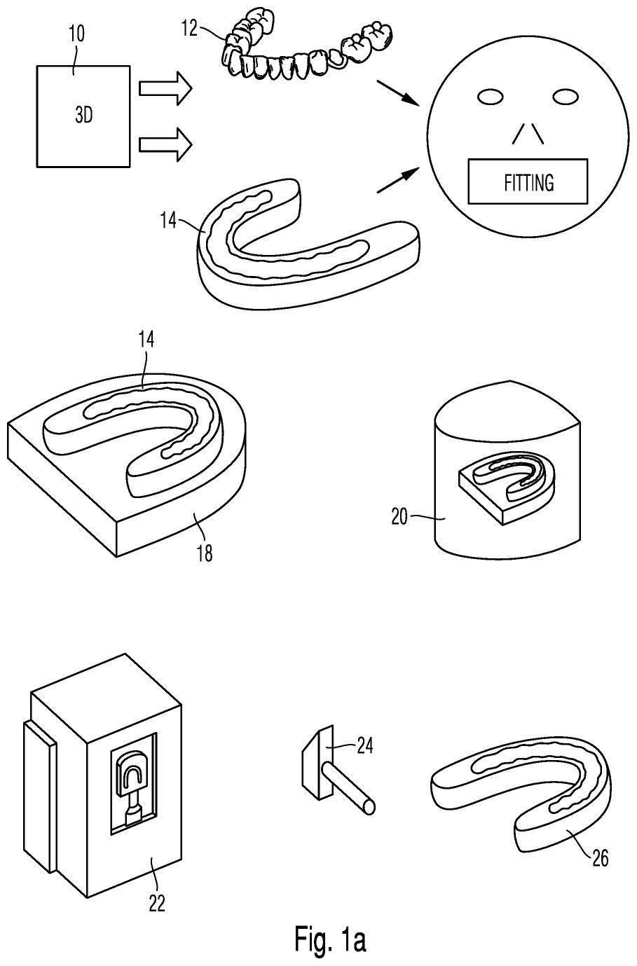

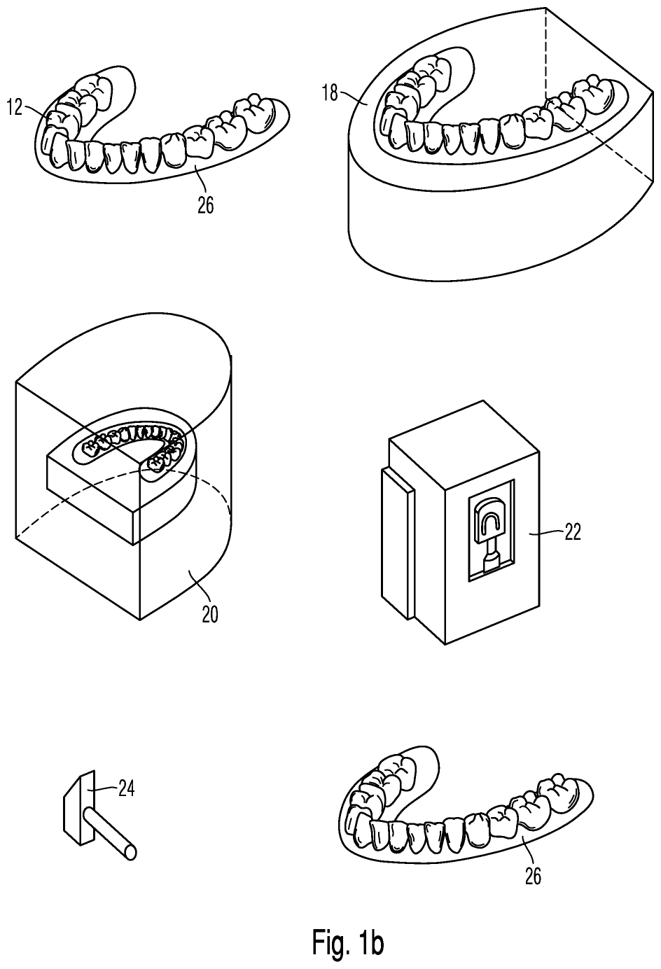

In one embodiment of the invention, the technical requirements for the invention are schematically shown in FIGS. 1a and 1b.

A 3D printer 10 is provided, in which a dental crown 12 and a prosthesis base 14 can be produced from inexpensive 3D printing material as positive models according to specifications. The dental crown is also known as the dental arch.

If required, these two positive models can be quickly joined together and used for a fitting on the patient. However, this step may also be omitted.

In the following, one of the two possibilities is described with regard to the order of handling, namely first generating the base 14.

It is to be understood that the dental crown 12 may also be produced first in an appropriate manner.

In this example, the prosthesis base is created first. For this purpose, the prosthesis base model 14 is placed in a cuvette 18 and cast with a suitable negative mold fabrication material, i.e. a casting compound such as silicone or plaster.

Following curing of the casting compound, the casting compound together with the positive model is placed in a brewing pot or similar device and the positive model is removed.

This leaves a negative mold. The negative mold is now placed again in the cuvette 18, if not already there.

The cuvette 18 is now inserted into an injector, such as the IvoBase injector 22 from Ivoclar Vivadent AG, in a manner known per se.

Prosthetic base material is provided and injected into the cuvette. The prosthesis base material is pressurized and enters the cavity of the negative mold corresponding to the prosthesis base positive model.

Preferably, the injection pressure is first applied at a moderate level and is then increased to the end value.

The negative mold is filled up with prosthesis base material, ensuring that the air present therein may escape on the opposite side without losing base material.

While maintaining the injection pressure, the heat required for polymerization is supplied and pressure and heat are maintained during the injection period.

Upon completion of the polymerization, the pressure is continuously reduced as is the temperature.

It is to be understood that the cuvette 18 is dimensioned to withstand the injection pressure. The cuvette is preferably configured in two parts and therefore comprises an upper side and a lower side which are essentially parallel to the occlusion plane.

The two halves of the cuvette are compressed by the injection pressure using a force that exceeds the injection pressure, e.g. 10000 N.

Depending on the dental restorative material used, the entire injection process may take one hour, for example, or more or less.

After cooling down, the casting mold, i.e. the cured casting compound, is removed with a suitable striker 24.

In this respect, the prosthesis base is already made of prosthesis base material.

At this point, the positive model of the dental arch 12 is assembled with the finished prosthesis base 26.

According to the invention, a hybrid model consisting of a dental restoration part (i.e. the prosthesis base) and a positive model has been realized at this time.

The combined prosthesis base 26 and the dental arch positive model 12 is now placed into the cleaned and restituted cuvette 18 and is again filled with a suitable casting compound, wherein, for example, plaster or silicone may be used.

Following curing of the casting compound, the positive model of the dental arch is liquefied in the brewing pot 20 or any other suitable removal device and is removed.

The temperature is required to be selected such that it is above the melting temperature of the positive model but below the softening temperature of the prosthesis base 26.

In this condition, there is a negative mold for the dental arch, consisting of the casting compound and the prosthesis base 26.

This negative mold is now reinserted into the injector 22 and dental arch material is injected in the same way as described above, but adapted to the material.

This step may also be configured in two parts by first injecting dentin mass and then incisal mass, in the appropriate order. In this multi-part solution, the dental arch model is divided into a dentin positive model and an incisal mass positive model.

After building up the injection pressure and heating while maintaining the injection pressure, polymerization is carried out in the same way as described above.

This is followed by cooling, and the casting compound is removed from the finished prosthesis, for example also using a striker 24. The finished prosthesis is then typically reprocessed, i.e. cleaned, especially in the interdental spaces, and polished.

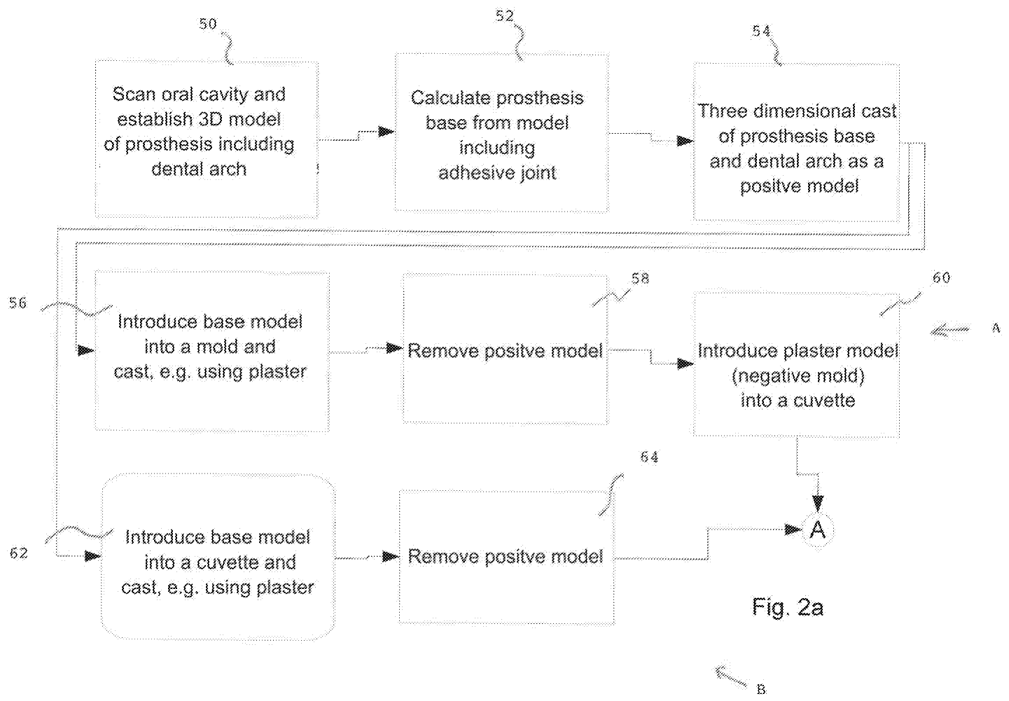

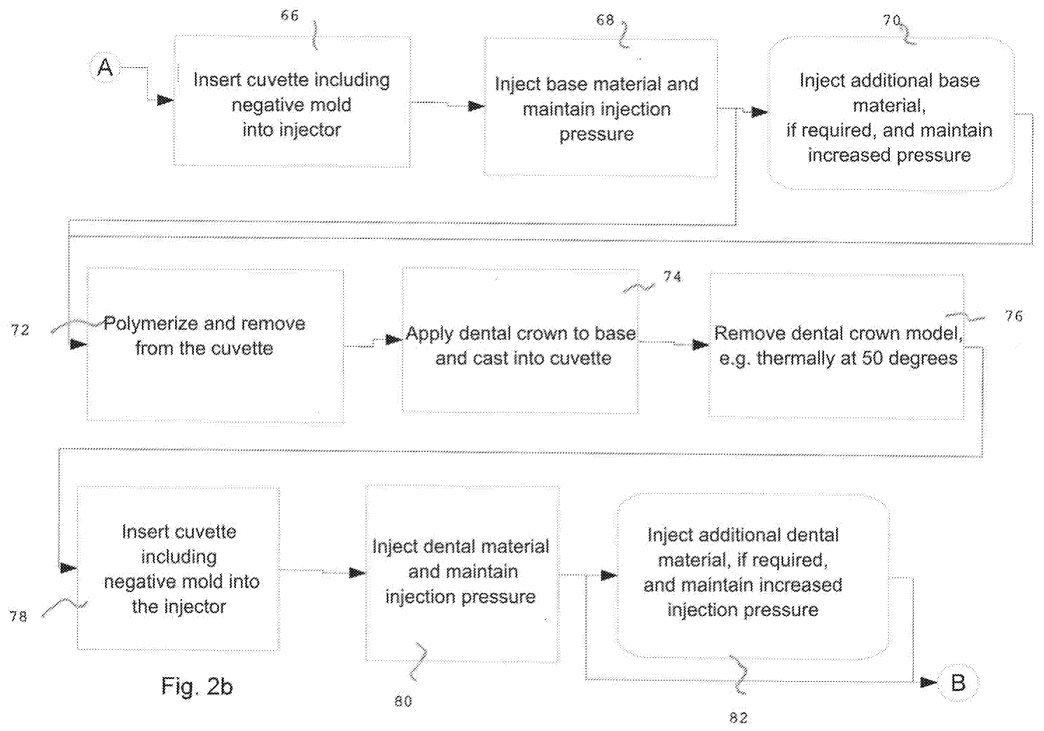

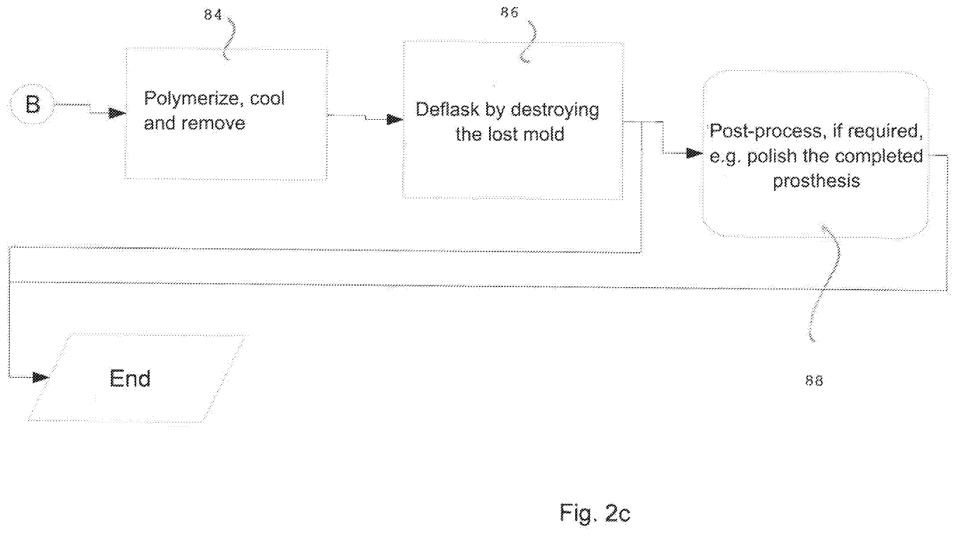

The process steps described herein are shown in FIGS. 2a to 2c in a slightly modified form of the process in the form of a flow diagram.

In step 50, a scan of the oral cavity is performed and a 3D model of the prosthesis including the dental arch is produced.

In step 52, the prosthesis base is calculated from the model, including the adhesive joint. The desired dividing line between the dental arch and the prosthesis base is therefore determined.

It is to be understood that an impression may be taken with impression material in the conventional way, and the impression produced in this way can be scanned. This avoids use of intraoral scanners and the possible inaccuracy caused by patient movement and the like.

In step 54, the prosthesis base and the elastomeric element are three-dimensionally printed as a positive model in the embodiment according to FIG. 2. A well-known low-cost 3D printer may be used for this purpose.

In the alternative A, the prosthesis base model is now placed in a mold and cast with plaster. Alternatively, it may as well be encapsulated with silicone. This is done in step 56.

In the alternative A, the positive model is removed in step 58, for example by brewing.

In step 60, the plaster mold or silicone mold is placed in a cuvette.

Alternatively to steps 56 to 60, the base model may also be placed in a cuvette as described in alternative B and the cuvette may be filled with silicone or plaster as described in step 62.

The positive model is then removed according to step 64, for example by thermal treatment.

The two alternatives A and B will be completed with steps 60 and 64 respectively, and as in FIG. 2b, in the next step 66, the cuvette with the negative mold is inserted into an injector 22 in both cases.

The base material is injected in step 68 and, while maintaining the injection pressure, the cuvette is heated in injection 22.

In step 70, further pressing and injection of further base material takes place, wherein any existing air bubbles are removed or separated, and it is ensured for material shrinkage not to subsequently occur.

The casting material is removed so that the finished prosthesis base 26 is exposed. It will be cleaned if necessary.

After polymerization in step 72, the cuvette and its contents are removed from the injector. The cuvette cools down and the dental crown model 12 generated in step 54 is applied to the existing prosthesis base 26 in step 74. The combination of the positive model of the dental crown and the completed prosthesis base 26 is cast again.

In step 76, the dental crown model is removed, for example by thermal treatment at 50 degrees. At this temperature, the prosthesis base does not melt or soften yet, so that the existing negative mold extends between the finished prosthesis base and the casting compound surrounding the positive model of the dental crown.

In this state, the cuvette is returned into the injector in step 78, and dental material is injected into the existing cavity of the dental arch or dental crown in step 80.

The injection pressure is maintained and the thermal treatment is carried out until all cavities are filled in step 82, so that polymerization can take place in step 84.

The cuvette is cooled down and removed from the injector in a manner known per se.

Demolding is performed, for example with the striker 24, in step 86.

In step 88, post-processing is carried out, for example, by polishing. The prosthesis is now completely finished.

While herein in turn, the embodiment is realized by first preparing the base, it is to be understood that instead, the dental arch or crown may also be produced first. Then, in step 56, the dental crown model is used instead of the base model, and this in turn is first used in the following steps.

It is to be understood that numerous alternatives may easily be realized using the inventive method. For example, mechanical pressing could also be performed in a pressurized vessel, and followed by polymerization, carried out as described above.

Any rapid prototyping process may alternatively be used for 3D printing. For example, realization of thermoplastics via FDM would be possible at low cost. Alternatively, water-soluble materials could be employed, which could then be dissolved in water in the removal steps 58, 64 and 76.

Any suitable materials can be considered for the casting compound, wherein gypsum-free materials are actually preferred. Also, curing polyurethane foams could be taken into account. Silicones are as well possible, but comparatively expensive.

1. A dental prosthesis manufacturing method comprising
additively or subtractively producing a positive model of a prosthesis base or partial prosthesis base,
encapsulating the positive model with a curing negative mold casting manufacturing material,
curing the casting material,
removing the positive model to produce a negative mold of the base, and
injecting the produced negative mold of the base with prosthesis material and curing the prosthesis material to produce the base,
wherein a tooth crown positive model is subsequently applied to the base and embedded together therewith,
wherein the tooth crown positive model is subsequently removed and a free space created therefrom is filled with dental material by injection and is cured providing a base and tooth crown.

2. The dental prosthesis manufacturing method according to claim 1,
wherein a positive model for a tooth crown and the base are each produced by 3D printing,
wherein the negative mold casting manufacturing material comprises plaster,
wherein the positive model is removed by action of heat.

3. A dental prosthesis manufacturing method comprising
additively or subtractively producing a positive model of a tooth crown,
encapsulating the positive model with a curing negative mold manufacturing material,
curing the manufacturing material,
removing the positive model action to produce a negative mold of the tooth crown,
injecting the produced negative mold of the tooth crown with prosthesis material and curing the prosthesis material to produce the tooth crown,
wherein a base positive model is subsequently applied to the tooth crown and is embedded together with the tooth crown,
wherein the base positive model is subsequently removed and a free space created therefrom is filled with base material by injection and cured providing a base and tooth crown.

4. The dental prosthesis manufacturing method according to claim 3,
wherein a positive model for a tooth crown and the base are each produced by 3D printing,
wherein the negative mold casting manufacturing material comprises plaster,
wherein the positive model is removed by action of heat.

5. The dental prosthesis manufacturing method according to claim 1,
wherein the positive model is used for a try-in in a patient.

6. The dental prosthesis manufacturing method according to claim 5,
wherein corrections are made to the positive model following or during try-in, before further use thereof.

7. The dental prosthesis manufacturing method according to claim 1,
wherein manufacture of the dental prosthesis is carried out in at least two steps,
wherein in one step a positive model of the prosthesis base is produced by 3D printing, the positive model is cast with casting material to form a casting mold, the casting mold is scalded, and prosthesis base material is injected into the casting mold produced therefrom.

8. The dental prosthesis manufacturing method according to claim 3,
wherein manufacture of the dental prosthesis is carried out in at least two steps,
wherein in one step a positive model of the tooth crown is produced by 3D printing, the positive model is cast with casting material to form a casting mold, the casting mold is scalded, and tooth crown material is injected into the casting mold produced therefrom.

9. The dental prosthesis manufacturing method according to claim 1,
wherein, in a further step, a positive model of the tooth crown required for the prosthesis is additively or subtractively produced,
the positive model is placed onto the previously produced prosthesis base and cast,
the cured casting mold is removed and a negative casting mold produced therefrom for the tooth crown is used at least as a part of the mold for injecting the tooth crown, the injection taking place in two steps comprising injecting a first dentine mass and subsequently injecting a cutting mass.

10. The dental prosthesis manufacturing method according to claim 9,
wherein another portion of the mold for injecting the tooth crown is a gingival portion of the finished injected prosthesis base

11. The dental prosthesis manufacturing method according to claim 1,
wherein deflasking the prosthesis base takes place together with deflasking the teeth or the tooth crown, after the prosthesis base and the tooth crown are polymerized to each other, or are bonded to each other.

12. The dental prosthesis manufacturing method according to claim 1,
wherein the positive model is manufactured from a dimensionally stable, 3D printing material comprising mono(meth)acrylates or di(meth)acrylates which can be processed in a stereolithography apparatus or MultiJet Printing (MJM) apparatus, and which 3D printing materials are easily removable.

13. The dental prosthesis manufacturing method according to claim 1,
wherein the positive model is produced from wax or thermoplastics in a cost-effective 3D printer.

14. The dental prosthesis manufacturing method according to claim 13,
wherein the 3D printer comprises a Fused Deposition Modeling (FDM) device, stereolithography printer or MJM device, and
wherein polylactides, polypropylene, polyethylene, acrylonitrile butadiene styrene, glycol-modified polyethylene terephthalate, and/or filled filaments are used as a thermoplastic material.

15. The dental prosthesis manufacturing method according to claim 1,
wherein injection of the prosthesis material, the prosthesis base material and/or the tooth crown material takes place via an injection molding device which has an air outlet which closes automatically upon impact of the material.

16. The dental prosthesis manufacturing method according to claim 15,
wherein the injection molding device comprises an ivobase injector.

17. The dental prosthesis manufacturing method according to claim 1,
wherein the negative mold is produced in a cuvette having an upper and a lower half, which are separable from each other.

18. The dental prosthesis manufacturing method according to claim 1,
wherein the tooth crown material is filled with prepolymer fillers, inorganic fillers or inorganically filled polymer fillers.

19. A dental prosthesis, comprising a prosthesis base and a tooth crown, manufactured by the method according to claim 1.
